(19) United States
(12) Patent Application Publication
(10) Pub. No.: US 2017/0336743 A1
(43) Pub. Date: Nov. 23, 2017

(54) FUSING ROLLER WITH VARIABLE HEATING

(71) Applicant: THE IMAGING SYSTEMS GROUP INC., Calgary (CA)

(72) Inventors: Mark HOPKINS, Calgary (CA); James DOMBESKI, Calgary (CA); Bruce EISENTRAUT, Calgary (CA)

(21) Appl. No.: 15/459,682

(22) Filed: Mar. 15, 2017

Related U.S. Application Data
(60) Provisional application No. 62/339,473, filed on May 20, 2016.

(51) Int. Cl. G03G 15/20

(52) U.S. Cl. CPC G03G 15/2078; G03G 15/2053; G03G 2215/2006

(57) ABSTRACT

A fuser unit for a hot fuse printer system includes a heating roller having a heating element which does not extend the entire length of the roller. The roller may include at least two heating elements, one of which heats a first heating zone and the other which heats a second heating zone.

### FIELD OF THE INVENTION

The present invention relates to a fusing roller or belt comprising a heating element which does not extend the entire length of the roller or belt.

### BACKGROUND

A printer system which bonds toner to a substrate using a combination of heat and pressure is conventionally known as a hot fuse printer system. Hot fuse printer systems may be adapted to print on continuous roll or fanfold media with a hot fusing roller. In such systems, the print media acts as a heat sink by absorbing or pulling heat away from the surface of the fusing roller.

Accordingly, when the media is narrower than the full width of the fusing roller, the areas where there is no media contacting the fusing rollers will rapidly increase in temperature. If the roller is unable to dissipate this heat fast enough, the fuser will overheat and fail.

### SUMMARY OF THE INVENTION

In one aspect, the invention may comprise a fuser unit for a hot fuse printer system, the fuser unit comprising a heating roller having a heating element which does not extend the entire length of the roller. In one embodiment, the roller comprises a first heating zone and a second heating zone, wherein the roller comprises at least two heating elements, one of which heats at least the first heating zone and the other which heats at least the second heating zone.

In one embodiment, there are three or more heating elements which correspond to three or more heating zones.

In one embodiment, the first heating zone includes the second heating zone but is longer. In one embodiment, each of the heating zones are centred on the roller but have different lengths. In an alternative embodiment, each of the heating zones are right or left justified but have different lengths.

In another aspect, the invention comprises a method of hot fuse printing on media narrower than the length of a heating roller, comprising the step of installing a heating roller having a heating element substantially the same length as the width of the print media.

### BRIEF DESCRIPTION OF THE DRAWINGS

FIG. 1 illustrates one embodiment of a roller of the present invention.

FIG. 2 illustrates an alternative embodiment of a roller of the present invention.

FIG. 3 illustrates another embodiment having a single heating element which does not extend the length of the tube.

FIG. 4 shows a schematic view of a switch control module and a roller having three heating elements.

### DETAILED DESCRIPTION

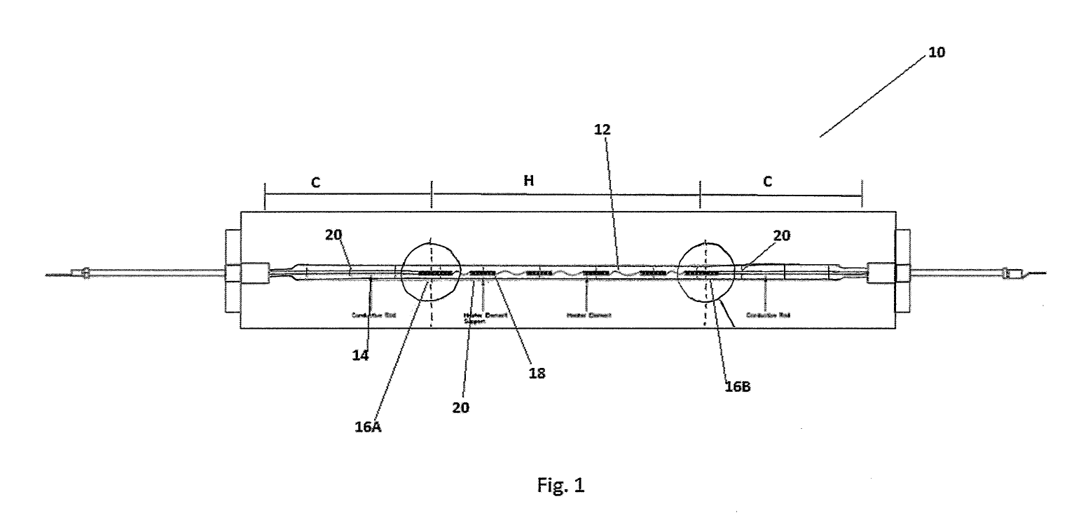

In one embodiment, the invention comprises a fuser unit for a hot fuse printer system, the fuser unit comprising a roller (10) which comprises a heating element (12) which does not extend the entire length of the roller, as is shown in FIG. 1. In alternative embodiments, the invention may be adapted for use with a fuser unit have belts and rollers. A belt will have a width which corresponds to a length of a roller.

In one embodiment, the heating element (12) is disposed within the roller (10) as is well known in the art, and comprises a conductive rod (14) and resistive heating coils (16) encased in a sealed tube (18), such as a quartz glass tube, and supported by heating element supports (20). The heating coils (16) may produce heat energy in the same manner as a light filament in a halogen lamp or an infrared heater. In one embodiment, the heating element (12) is centred in the roller (10), but in alternative embodiments the heating element may be left or right justified in the roller. Preferably, the terminal heating coil (16A, 16B) in the heating element, which is the heating coil disposed at the boundary of the heating zone (H), extends slightly beyond the heating zone, to assist in maintaining a relatively even temperature across the entire heating zone (H).

The hot zone (H) is accordingly centred in the roller, leaving cold zones (C) at both ends. Thus, this roller is suitable for print media which is not wider than the hot zone.

Fuser units are easily replaced in most printers, therefore, a plurality of different fuser units each having a roller with a different length heating element may be provided to allow for printing on variable width media.

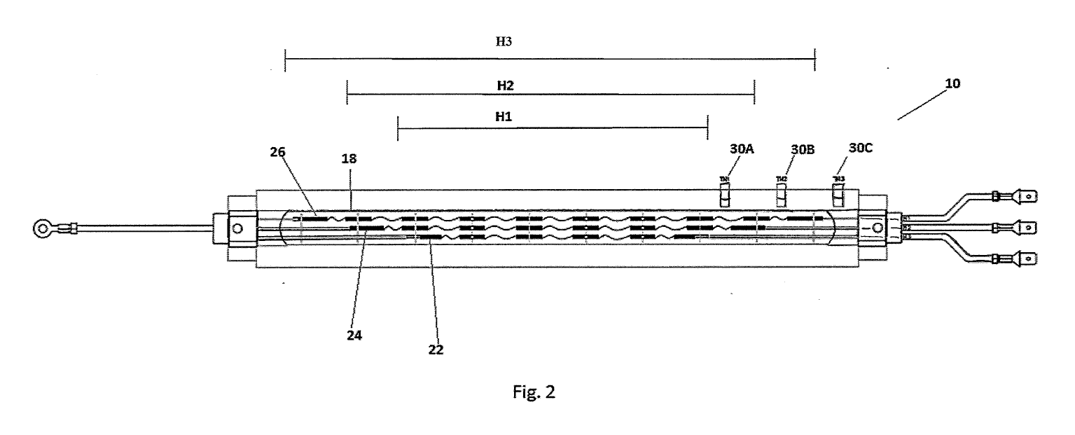

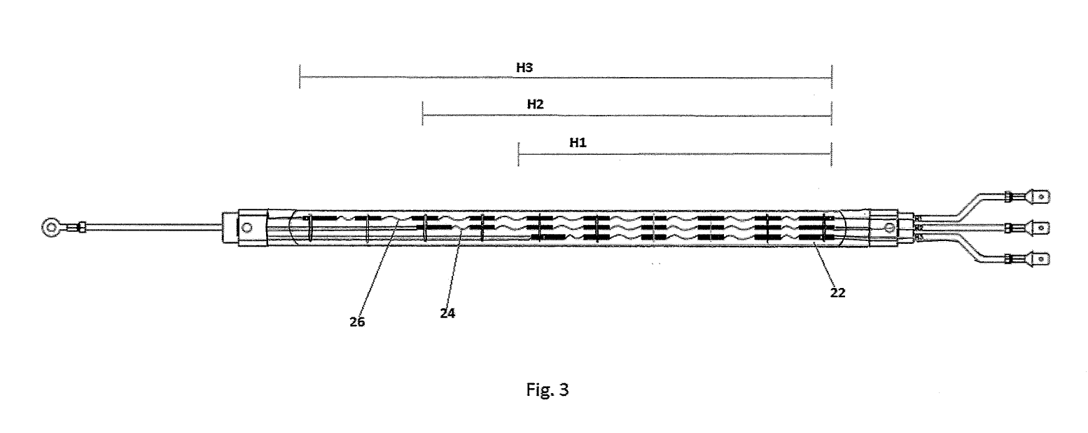

In one embodiment, the roller (10) may comprise multiple heating zones, wherein the roller comprises multiple heating elements, as is illustrated in FIGS. 2 and 3.

In one example, a heating roller (10) comprises three elongate heating elements within the roller. The first heating element (22) extends for only a portion of the entire length of the roller. A second heating element (24) extends for a larger portion of the length of the roller while a third heating element (26) extends for substantially the entire length of the roller.

Accordingly, the heating zone of the first heating element (H1) is only a portion of the length of the roller. The heating zone of the second heating element (H2) includes the first heating zone but extends further along the length of the roller, and the heating zone of the third heating element extends even further along the length of the roller, for example, substantially the entire length of the roller. The unheated or cold zones control the build up of heat on the surface of the fusing roller or belt.

In one embodiment, each of the heating elements are centred along the length of the roller (10), as is shown in FIG. 2. In an alternative embodiment, each of the heating elements is right or left justified in the roller, as is shown in FIG. 3. Each of the heating elements is connected to a separate power lead so as to allow independent control by a heating controller (40).

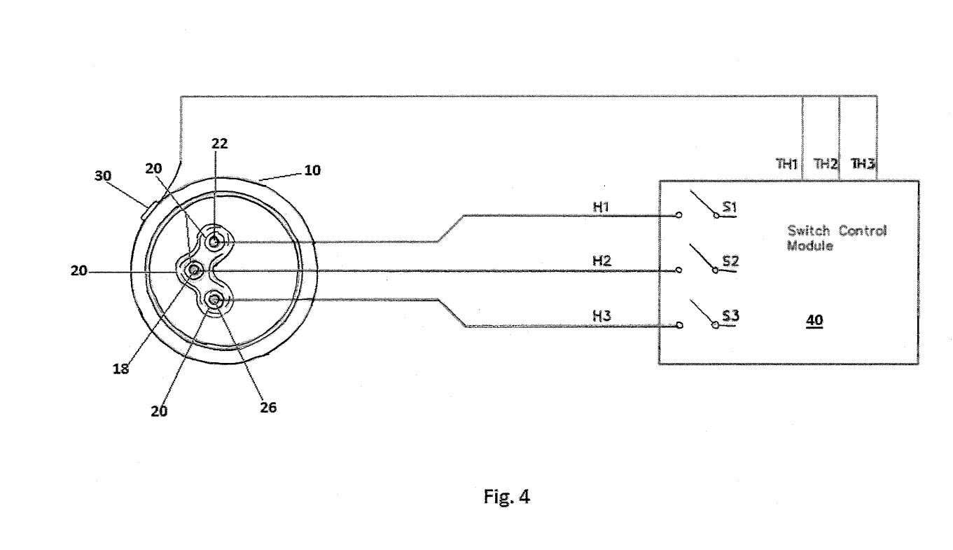

In one embodiment, as shown in FIG. 4, the multiple heating elements are disposed within a single heat transparent tube (18) disposed inside the roller (10). Alternatively, each heating element may be placed in an individual tube. This latter arrangement may permit the exchange or replacement of individual heating elements to vary or repair a roller.

In one embodiment, a plurality of temperature sensors (30), which may be any temperature sensing device, such as a thermistor, are configured to provide surface temperature information of the fusing roller to a controller. Preferably, a thermistor is placed just outside each heat zone. As shown in FIG. 2, a first thermistor (30A) is placed just outside of the first heat zone, and within the second and third heat zones. The second thermistor (30B) is placed just outside the second heat zone, but within the third heat zone. The third thermistor (30C) is placed just outside the third heat zone.

The heated roller shown in FIGS. 2 and 4 or FIGS. 3 and 4 may be controlled by a switch controller (40) which is connected to each of the thermistors (30) and operates to turn each heating element on and off automatically in response to a user input which determines the width of the media, or upon automatic detection of media width. Additionally, or alternatively, the switch controller may operate to turn heating elements on and off based on the temperature information it receives from the thermistors. For example, the switch controller may be configured to start with the longest heating element (26) and heat zone (H3). If the print media is narrower than heat zone (H3), then at least the third thermistor (30C) will register a higher temperature than the inner thermistors (30A, 30B). The switch controller may then turn off heating element (26) and turn on heating element (24). Similarly, the switch controller may turn off heating element (24) and turn on the shortest heating element (22) in response to temperature information.

Many printers have software or firmware which prevents operation unless the heating roller has reached a minimum temperature. In such cases, the printer may not operate if the outside thermistors are registering a temperature lower than the minimum. In one embodiment, the switch controller may be programmed with a startup algorithm which overrides this operation. Alternatively, the thermistor may be modified, such as with an additional resistor, to offset its lower end temperature curve and report at least a minimum temperature at all times.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated. To the extent that the following description is of a specific embodiment or a particular use of the invention, it is intended to be illustrative only, and not limiting of the claimed invention.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to combine, affect or connect such aspect, feature, structure, or characteristic with other embodiments, whether or not such connection or combination is explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

As will also be understood by one skilled in the art, all language such as “up to”, “at least”, “greater than”, “less than”, “more than”, “or more”, and the like, include the number recited. Such terms may refer to ranges that can be subsequently broken down into sub-ranges as discussed above.

What is claimed is:

1. A fuser unit for a hot fuse printer system, the fuser unit comprising a heating roller or belt having a heating element which does not extend the entire length of the roller or width of the belt.

2. The fuser unit of claim 1 wherein the roller or belt comprises at least two heating elements, one of which heats at least a first heating zone and the other which heats at least a second heating zone.

3. The fuser unit of claim 2 wherein are three or more heating elements which correspond to three or more heating zones.

4. The fuser unit of claim 2 wherein the heating zones overlap but are not contiguous.

5. The fuser unit of claim 2 wherein each of the heating zones are centred on the roller but have different lengths.

6. The fuser unit of claim 2 wherein each of the heating zones are right or left justified but have different lengths.

7. The fuser unit of claim 2 further comprising a temperature sensor positioned just outside each heating zone.

8. The fuser unit of claim 2 further comprising a heating element switch controller operatively connected to each heating element, configured to switch on or off each heating element.

9. The fuser unit of claim 7 further comprising a heating element switch controller operatively connected to each temperature sensor, configured to switch on or off each heating element in response to the temperature of the roller in each heating zone.

10. A method of hot fuse printing on media narrower than the length of a heating roller or width of a belt, comprising the step of installing a heating roller having a heating element substantially the same length as the width of the print media.

11. The method of claim 10, wherein the heating roller or belt comprises a plurality of heating elements, each of which heats a different heat zone of the roller or belt, and turning on the heating element which heats the zone matching the width of the print media.

12. The method of claim 11 wherein a controller automatically turns on or off the heating elements in response to the reported temperature from each heat zone.
